(19) United States
(12) Patent Application Publication
(10) Pub. No.: US 2023/0009269 A1
(43) Pub. Date: Jan. 12, 2023

(54) LIDAR ENHANCED POLYNOMIAL GENERATION FOR LANE CENTERING

(71) Applicant: APTIV TECHNOLOGIES LIMITED, St. Michael (BB)

(72) Inventor: Premchand Krishna Prasad, Westfield, IN (US)

(73) Assignee: APTIV TECHNOLOGIES LIMITED, St. Michael (BB)

(21) Appl. No.: 17/368,984

(22) Filed: Jul. 7, 2021

(51) Int. Cl. B60W 30/12; B60W 10/20; G06V 20/56; B60W 30/08; B60W 40/06

(52) U.S. Cl. CPC B60W 30/12; B60W 10/20; G06V 20/588; B60W 30/08; B60W 40/06; B60W 2420/52; B60W 2420/42; B60W 2510/20; B60W 2552/53

(57) ABSTRACT

A lane centering system for a vehicle includes a light detection and ranging (LIDAR) system configured to (i) emit light pulses towards raised pavement markers on a road along which the vehicle is traveling and (ii) receive light pulses reflected by the raised pavement markers that collectively form LIDAR point cloud data, and a controller configured to detect a set of lane lines defining one or more lanes on the road based on the LIDAR point cloud data, based on at least the detected set of lane lines_{;} generate a polynomial curve corresponding to a center of a lane in which the vehicle is traveling, and control steering of the vehicle based on the polynomial curve to keep the vehicle centered within the lane.

### FIELD

The present disclosure generally relates to vehicle lane centering and, more particularly, to light detection and ranging (LIDAR) enhanced polynomial generation for vehicle lane centering.

### BACKGROUND

Lane centering refers to the automated or autonomous procedure whereby a vehicle keeps itself centered within a lane, thereby temporarily relieving a driver of the task of steering the vehicle. Conventional vehicle lane centering is based on captured camera images and is generally sufficient for up L2 autonomous driving. For L2+ autonomous features where the driver's hands are off the wheel and his/her eyes are off the road, more robust sensing could be required. To do so, a better understanding of the environment and the road is needed. Thus, while conventional vehicle lane centering systems do work well for their intended purpose, there exists an opportunity for improvement in the relevant art.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a lane centering system for a vehicle is presented. In one exemplary implementation, the lane centering system comprises a light detection and ranging (LIDAR) system configured to (i) emit light pulses towards raised pavement markers on a road along which the vehicle is traveling and (ii) receive light pulses reflected by the raised pavement markers that collectively form LIDAR point cloud data and a controller configured to: detect a set of lane lines defining one or more lanes on the road based on the LIDAR point cloud data, based on at least the detected set of lane lines, generate a polynomial curve corresponding to a center of a lane in which the vehicle is traveling, and control steering of the vehicle based on the polynomial curve to keep the vehicle centered within the lane.

In some implementations, the controller is further configured to receive, from a set of e-horizon systems of the vehicle, e-horizon information including at least map-based data of a portion of the road in front of the vehicle. In some implementations, the controller is further configured to: receive, from a camera system of the vehicle, lane information for the road based on an analysis by the camera system of images captured by the camera system, and receive, from the camera system, confidence scores for the lane information for the road. In some implementations, when the lane information indicates no lane markers are present or the confidence scores for the lane information fail to satisfy a confidence score threshold, the controller is further configured to generate a blended polynomial curve based on a blending of the detected set of lane lines and the e-horizon information.

In some implementations, the controller is further configured to control the steering of the vehicle based on the blended polynomial curve for a calibratable period to keep the vehicle centered within the lane, and output a notification to the driver that lane markings are unavailable and the driver will need to takeover steering of the vehicle after the calibratable period. In some implementations, when the driver takes over steering of the vehicle after the calibratable period, lane centering of the vehicle disengages, and when the driver does not take over steering of the vehicle after the calibratable period, the controller is further configured to perform a minimum risk maneuver (MRM) including (i) generating an MRM blended polynomial curve based on at least a blending of the detected set of lane lines and the e-horizon information and (ii) controlling steering of the vehicle based on the MRM polynomial curve to keep the vehicle safely centered within the lane or safely pulled over on a side of the road. In some implementations, when the confidence scores for the lane information satisfy a confidence score threshold, the controller is configured to generate a blended polynomial curve based on a blending of the detected set of lane lines, the e-horizon information, and the lane information. In some implementations, the controller is configured to generate the polynomial curve based further on vehicle state data including at least one of vehicle speed, pitch, and yaw.

According to another aspect of the present disclosure, a lane centering method for a vehicle is presented. In one exemplary implementation, the method comprises; receiving, by a controller of the vehicle and from a light detection and ranging (LIDAR) system of the vehicle, LIDAR point cloud data, wherein the LIDAR system is configured to (i) emit light pulses towards raised pavement markers on a road along which the vehicle is traveling and (ii) receive light pulses reflected by the raised pavement markers that collectively form the LIDAR point cloud data, detecting, by the controller, a set of lane lines defining one or more lanes on the road based on the LIDAR point cloud data, based on at least the detected set of lane lines, generating, by the controller, a polynomial curve corresponding to a center of a lane in which the vehicle is traveling, and controlling, by the controller, steering of the vehicle based on the polynomial curve to keep the vehicle centered within the lane,

In some implementations, the method further comprises receiving, by the controller and from a set of e-horizon systems of the vehicle, e-horizon information including at least map-based data of a portion of the road in front of the vehicle. In some implementations, the method further comprises receiving, by the controller and from a camera system of the vehicle, lane information for the road based on an analysis by the camera system of images captured by the camera system, and receiving, by the controller and from the camera system, confidence scores for the lane information for the road. In some implementations, when the lane information indicates no lane markers are present or the confidence scores for the lane information fail to satisfy a confidence score threshold, the method further comprises generating, by the controller, a blended polynomial curve based on a blending of the detected set of lane lines and the e-horizon information. In some implementations, the method further comprises controlling, by the controller, the steering of the vehicle based on the blended polynomial curve for a calibratable period to keep the vehicle centered within the lane, and outputting, by the controller, a notification to the driver that lane markings are unavailable and the driver will need to takeover steering of the vehicle after the calibratable period.

In some implementations, when the driver takes over steering of the vehicle after the calibratable period, lane centering of the vehicle disengages, and when the driver does not take over steering of the vehicle after the calibratable period, the method further comprises performing, by the controller, a minimum risk maneuver (MRM) including (i) generating an MRM blended polynomial curve based on at least a blending of the detected set of lane lines and the e-horizon information and (ii) controlling steering of the vehicle based on the MRM polynomial curve to keep the vehicle safely centered within the lane or safely pulled over on a side of the road. In some implementations, when the confidence scores for the lane information satisfy a confidence score threshold, the method further comprises generating, by the controller, a blended polynomial curve based on a blending of the detected set of lane lines, the e-horizon information, and the lane information, and controlling, by the controller, the steering of the vehicle based on the blended polynomial curve to keep the vehicle centered within the lane. In some implementations, generating, by the controller, the polynomial curve is based further on vehicle state data including at least one of vehicle speed, pitch, and yaw.

According to yet another aspect of the present disclosure, a lane centering system for a vehicle is presented. In one exemplary implementation, the lane centering system comprises: a light detection and ranging (LIDAR) means for (i) emitting light pulses towards raised pavement markers on a road along which the vehicle is traveling and (ii) receiving light pulses reflected by the raised pavement markers that collectively form LIDAR point cloud data, and control means for: detecting a set of lane lines defining one or more lanes on the road based on the LIDAR point cloud data, based on at least the detected set of lane lines, generating a polynomial curve corresponding to a center of a lane in which the vehicle is traveling, and controlling steering of the vehicle based on the polynomial curve to keep the vehicle centered within the lane.

In some implementations, the control means receives, from a set of e-horizon means of the vehicle, e-horizon information including map-based data of a portion of the road in front of the vehicle. In some implementations, the control means: receives, from a camera means of the vehicle, lane information for the road based on an analysis by the camera system of images captured by the camera means, and receives, from the camera means, confidence scores for the lane information for the road. In some implementations, when the lane information indicates no lane markers are present or the confidence scores for the lane information fail to satisfy a confidence score threshold, the control means: generates a blended polynomial curve based on a blending of the detected set of lane lines and the e-horizon information, controls the steering of the vehicle based on the blended polynomial curve for a calibratable period to keep the vehicle centered within the lane, and outputs a notification to the driver that lane markings are unavailable and the driver will need to takeover steering of the vehicle after the calibratable period.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. I is a functional block diagram of a vehicle having an example lane centering system according to the principles of the present disclosure; and

FIG. 2 is a flow diagram of an example lane centering method for a vehicle according to the principles of the present disclosure.

### DETAILED DESCRIPTION

As discussed above, there exists an opportunity for improvement in the art of vehicle lane centering. One solution to improving vehicle lane centering is known as e-horizon, which combines captured camera images (the vehicle's vision) with other information (e.g., map data) to obtain predictive information about what is beyond the vehicle's vision. By leveraging this additional information, decision making by the vehicle can be improved. There are instances, however, when captured camera images are poor quality and thus the vehicle's vision may be inadequate to perform lane centering (e.g., in rainy or other poor weather conditions). Accordingly, improved vehicle lane centering systems and methods are presented herein that utilize a light detection and ranging (LIDAR) system of the vehicle to detect raised pavement markers (e.g., light emitting diode (LED) raised pavement markers). By detecting these raised pavement markers, the vehicle is able to detect lane lines and utilize this information, along with other information, to generate a better polynomial curve for use in vehicle lane centering.

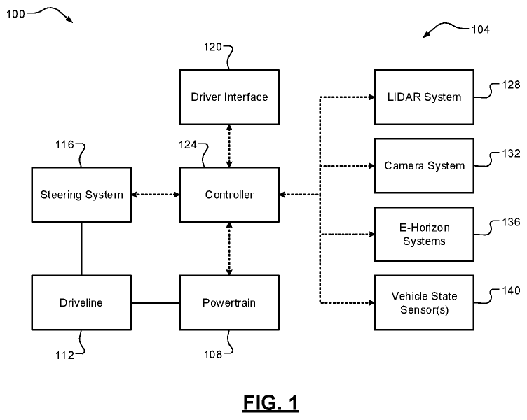

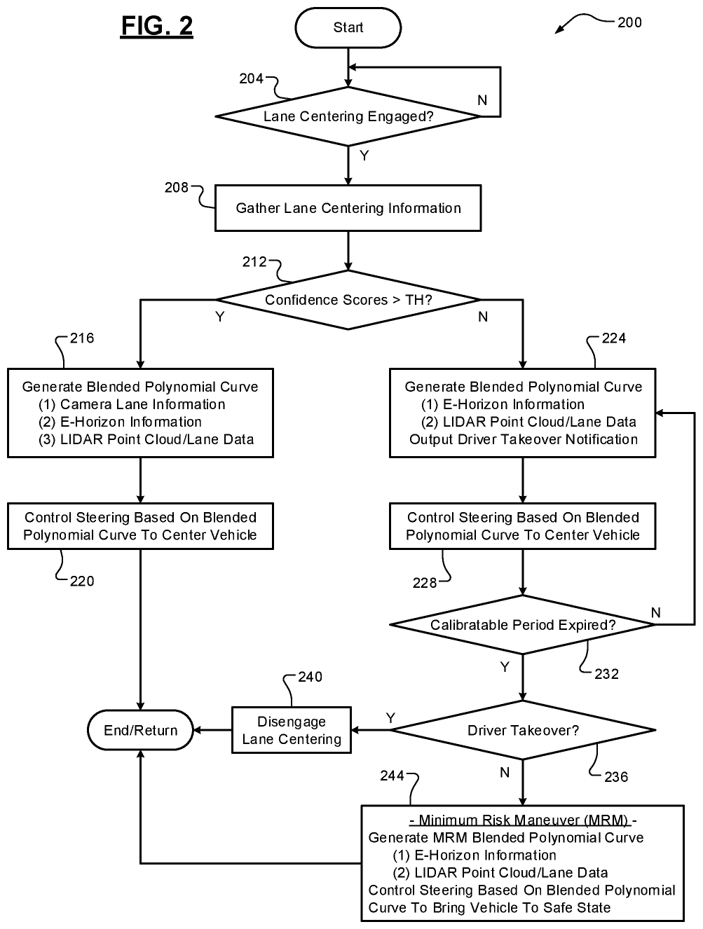

Referring now to FIG. 1, a functional block diagram of a vehicle 100 having an example lane centering system 104 according to the principles of the present disclosure is illustrated. The vehicle 100 generally comprises a powertrain 108 configured to generate and transfer drive torque to a driveline 112 of the vehicle 100 for propulsion. A steering system 116 comprises a system of actuators that control steering of the vehicle 100 (e.g., in response to driver input via a driver interface 120, such as a steering wheel). The steering system 116 can also be autonomously controlled by a controller 124 of the vehicle 100, such as to perform lane centering. The vehicle 100 further comprises a LIDAR system 128, a camera system 132 (e.g., a front-facing camera system), a set of e-horizon systems 136 (a global navigation satellite system (GNSS) receiver, a real-time kinematic (RTK) system, a vehicle-to-everything (V2X) communication system, a high-definition (HD) map system, etc.). The vehicle 100 further comprises a set of vehicle state sensors 140 that monitor vehicle state data such as, but not limited to, vehicle speed, pitch, and yaw, which could also be utilized in generation of a polynomial curve for autonomous lane centering control of the vehicle 100. As previously mentioned, the controller 124 is configured to perform the lane centering techniques of the present disclosure, which will now be described in greater detail with respect to FIG. 2.

Referring now to FIG. 2, a flow diagram of an example lane centering method 200 for a vehicle according to the principles of the present disclosure is illustrated. While the components of vehicle 100 will be hereinafter referenced, it will be appreciated that this method 200 could be applicable to any suitable vehicle having the requisite systems/sensors. At 204, the controller 124 determines whether lane centering is engaged or active. When false, the method 200 ends or returns to 204. When true, the method 200 proceeds to 208. At 208, the controller 124 gathers information from a plurality of different sources for potential use in performing lane centering. This includes at least (i) from the camera system, lane information for a road along which the vehicle 100 is traveling based on an analysis by the camera system 132 of images captured by the camera system 132 and confidence scores for the lane information for the road, (ii) from the e-horizon systems 136, e-horizon information including at least map-based data of a portion of the road in front of the vehicle 100, and (iii) from the LIDAR system 128, LIDAR point cloud data obtained by the LIDAR system 128 emitting light pulses towards raised pavement markers (e.g., LED raised pavement markers) on the road and receiving light pulses reflected by the raised pavement markers that collectively form the LIDAR point cloud data. After collecting all of this information at 204, the method 200 proceeds to 212.

At 212, the controller 124 determines whether the confidence scores for the lane information provided by the camera system 132 satisfy a confidence score threshold. When true, the method 200 proceeds to 216. When false, the method 200 proceeds to 224. At 216, the controller 124 generates a blended polynomial curve corresponding to a center of a lane in which the vehicle 100 is traveling based on the lane information, the e-horizon information, and the LIDAR point cloud data (e.g., lane lines detected from the LIDAR point cloud data) and at 220 the controller 124 controls steering of the vehicle 100 based on the blended polynomial curve to keep the vehicle 100 centered within the lane. The method 200 then ends or returns to 204. At 224, the controller 124 determines that the lane information from the camera system 132 is not reliable enough to use for lane centering. For example, rainy or other poor conditions (fog, darkness, etc.) could cause the lane information to have low confidence scores. Thus, at 224, the controller 124 generates a blended polynomial curve corresponding to a center of the lane in which the vehicle 100 is traveling based on the e-horizon information and the LIDAR point cloud data (e.g., lane lines detected from the LIDAR point cloud data).

At 228, the controller 124 controls the steering of the vehicle 100 based on the blended polynomial curve to keep the vehicle 100 centered within the lane and also outputs a notification to the driver (e.g., via driver interface 120) that the driver will need to takeover control of the vehicle 100 after a calibratable period as the lane information from the camera system 132 is unavailable (unreliable). At 232, the controller 124 determines whether the calibratable period has expired. When false, the method 200 returns to 224 or 228. When true, the method 200 proceeds to 236. At 236, the controller 124 determines whether the driver has taken over steering control of the vehicle 100. When true, lane centering disengages at 240 and the method 200 ends or returns to 204. When false, the method 200 proceeds to 244 where the controller 124 performs a minimum risk maneuver (MRM) to bring the vehicle 100 to a safe state. This involves generating a blended polynomial curve based on the e-horizon information, the LIDAR point cloud data (e.g., lane lines detected from the LIDAR point cloud data), and other perception sensor data (e.g., indicative of whether or not the vehicle 100 can safely exit its lane) and controlling the steering of the vehicle 100 based on the blended polynomial curve. Thus, the blended polynomial curve could either keep the vehicle 100 safely centered within the lane or it could guide the vehicle 100 safely to a side of the road. This MRM could also include slowing the vehicle 100 to a safe speed or to a full stop. The method 200 then ends.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system_{;}or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure,

What is claimed is:

1. A lane centering system for a vehicle, the lane centering system comprising:
a light detection and ranging (LIDAR) system configured to (i) emit light pulses towards raised pavement markers on a road along which the vehicle is traveling and (ii) receive light pulses reflected by the raised pavement markers that collectively form LIDAR point cloud data; and
a controller configured to:
detect a set of lane lines defining one or more lanes on the road based on the LIDAR point cloud data;
based on at least the detected set of lane lines, generate a polynomial curve corresponding to a center of a lane in which the vehicle is traveling; and
control steering of the vehicle based on the polynomial curve to keep the vehicle centered within the lane.

2. The lane centering system of claim 1, wherein the controller is further configured to receive, from a set of e-horizon systems of the vehicle, e-horizon information including at least map-based data of a portion of the road in front of the vehicle.

3. The lane centering system of claim 2, wherein the controller is further configured to:
receive, from a camera system of the vehicle, lane information for the road based on an analysis by the camera system of images captured by the camera system; and
receive, from the camera system, confidence scores for the lane information for the road.

4. The lane centering system of claim 3, wherein when the lane information indicates no lane markers are present or the confidence scores for the lane information fail to satisfy a confidence score threshold, the controller is further configured to generate a blended polynomial curve based on a blending of the detected set of lane lines and the e-horizon information.

5. The lane centering system of claim 4, wherein the controller is further configured to:
control the steering of the vehicle based on the blended polynomial curve for a calibratable period to keep the vehicle centered within the lane; and
output a notification to the driver that lane markings are unavailable and the driver will need to takeover steering of the vehicle after the calibratable period.

6. The lane centering system of claim 5, wherein:
when the driver takes over steering of the vehicle after the calibratable period, lane centering of the vehicle disengages; and
when the driver does not take over steering of the vehicle after the calibratable period, the controller is further configured to perform a minimum risk maneuver (MRM) including (i) generating an MRM blended polynomial curve based on at least a blending of the detected set of lane lines and the e-horizon information and (ii) controlling steering of the vehicle based on the MRM polynomial curve to keep the vehicle safely centered within the lane or safely pulled over on a side of the road.

7. The lane centering system of claim 3, wherein when the confidence scores for the lane information satisfy a confidence score threshold, the controller is configured to generate a blended polynomial curve based on a blending of the detected set of lane lines, the e-horizon information, and the lane information.

8. The lane centering system of claim 1, wherein the controller is configured to generate the polynomial curve based further on vehicle state data including at least one of vehicle speed, pitch, and yaw.

9. A lane centering method for a vehicle, the method comprising:
receiving, by a controller of the vehicle and from a light detection and ranging (LIDAR) system of the vehicle, LIDAR point cloud data, wherein the LIDAR system is configured to (i) emit light pulses towards raised pavement markers on a road along which the vehicle is traveling and (ii) receive light pulses reflected by the raised pavement markers that collectively form the LIDAR point cloud data;
detecting, by the controller, a set of lane lines defining one or more lanes on the road based on the LIDAR point cloud data;
based on at least the detected set of lane lines, generating, by the controller, a polynomial curve corresponding to a center of a lane in which the vehicle is traveling; and
controlling, by the controller, steering of the vehicle based on the polynomial curve to keep the vehicle centered within the lane.

10. The method of claim 9, further comprising receiving, by the controller and from a set of e-horizon systems of the vehicle, e-horizon information including at least map-based data of a portion of the road in front of the vehicle.

11. The method of claim 10, further comprising:
receiving, by the controller and from a camera system of the vehicle, lane information for the road based on an analysis by the camera system of images captured by the camera system; and
receiving, by the controller and from the camera system, confidence scores for he lane information for the road.

12. The method of claim 11, wherein when the lane information indicates no lane markers are present or the confidence scores for the lane information fail to satisfy a confidence score threshold, the method further comprises generating, by the controller, a blended polynomial curve based on a blending of the detected set of lane lines and the e-horizon information.

13. The method of claim 12, further comprising:
controlling, by the controller, the steering of the vehicle based on the blended polynomial curve for a calibratable period to keep the vehicle centered within the lane; and
outputting, by the controller, a notification to the driver that lane markings are unavailable and the driver will need to takeover steering of the vehicle after the calibratable period.

14. The method of claim 13, wherein:
when the driver takes over steering of the vehicle after the calibratable period, lane centering of the vehicle disengages; and
when the driver does not take over steering of the vehicle after the calibratable period, the method further comprises performing, by the controller, a minimum risk maneuver (MRM) including (i) generating an MRM blended polynomial curve based on at least a blending of the detected set of lane lines and the e-horizon information and (ii) controlling steering of the vehicle based on the MRM polynomial curve to keep the vehicle safely centered within the lane or safely pulled over on a side of the road.

15. The method of claim 11, wherein when the confidence scores for the lane information satisfy a confidence score threshold, the method further comprises generating, by the controller, a blended polynomial curve based on a blending of the detected set of lane lines, the e-horizon information, and the lane information, and controlling, by the controller, the steering of the vehicle based on the blended polynomial curve to keep the vehicle centered within the lane.

16. The method of claim 9, wherein generating, by the controller, the polynomial curve is based further on vehicle state data including at least one of vehicle speed, pitch, and yaw.

17. A lane centering system for a vehicle, the lane centering system comprising;
a light detection and ranging (LIDAR) means for (i) emitting light pulses towards raised pavement markers on a road along which the vehicle is traveling and (ii) receiving light pulses reflected by the raised pavement markers that collectively form LIDAR point cloud data; and
control means for:
detecting a set of lane lines defining one or more lanes on the road based on the LIDAR point cloud data;
based on at least the detected set of lane lines, generating a polynomial curve corresponding to a center of a lane in which the vehicle is traveling; and
controlling steering of the vehicle based on the polynomial curve to keep the vehicle centered within the lane.

18. The lane centering system of claim 17, wherein the control means receives, from a set of e-horizon means of the vehicle, e-horizon information including map-based data of a portion of the road in front of the vehicle.

19. The lane centering system of claim 18, wherein the control means:
receives, from a camera means of the vehicle, lane information for the road based on an analysis by the camera system of images captured by the camera means; and
receives, from the camera means, confidence scores for the lane information for the road.

20. The lane centering system of claim 3, wherein when the lane information indicates no lane markers are present or the confidence scores for the lane information fail to satisfy a confidence score threshold, the control means:
generates a blended polynomial curve based on a blending of the detected set of lane lines and the e-horizon information;
controls the steering of the vehicle based on the blended polynomial curve for a calibratable period to keep the vehicle centered within the lane; and
outputs a notification to the driver that lane markings are unavailable and the driver will need to takeover steering of the vehicle after the calibratable period.
